(19) United States
(12) Patent Application Publication
(10) Pub. No.: US 2007/0296203 A1
(43) Pub. Date: Dec. 27, 2007

(54) A Method and Apparatus for Providing Embossed Hidden Images

(76) Inventor: Ron Golan, Tel Aviv (IL)

Correspondence Address: PAUL, HASTINGS, JANOFSKY & WALKER LLP, 875 15th Street, NW, Washington, DC, 20005, US

(21) Appl. No.: 11/579,880

(22) PCT Filed:
(86) PCT No.: PCT/IL04/00947

Related U.S. Application Data
(63) Continuation-in-part of application No. PCT/IL2004/000354, filed on Apr. 28, 2004.

(30) Foreign Application Priority Data
May 10, 2004 (IL) 161904

(51) Int. Cl. B42D 15/00

(52) U.S. Cl. 283/72

(57) ABSTRACT

A method for providing a hidden image within a substrate the method comprising interaction of a laser irridation on a substrate. The interaction with the substrate according to one embodiment creates recesses on the substrate, the recesses form an at least one hidden image, whereby the at least one hidden image can be viewed with the use of at least one decoder. The decoder can be embossed in a similar manner.

### BACKGROUND OF THE INVENTION

1. Field of the Invention

The present invention relates to a method and apparatus for providing hidden images, in general, and to a method and apparatus for providing hidden images within substrates by a laser beam, in particular.

2. Discussion of the Related Art

Many billions of U.S. Dollars are lost annually as a result of counterfeiting of valuable papers such as bank papers notes, bank checks, formal documents and the like. Additionally, great financial loses result from counterfeiting and forging of brand labels, licenses and the like. Subject to the dramatic development of copying machines, scanners the path for dishonest behavior by scanning, copying and duplication of highly resembled to originals of printed matter is becoming convenient and prevalent. Consequently, there is an extensive requirement for counter measurements to prevent counterfeiting of documents as well as other printed matter and products. One leading measure for counterfeiting detection is achieved by using hidden images. Hidden images, also known as concealed images or icons, can also be used in the fields of marketing and promoting goods and services. In addition, the authenticity of documents is of great import in the conduction of commercial transaction.

The term “hidden image” is generally used in the printing industry to describe a hidden pattern printed on paper. The hidden image is composed of printed ink dots and lines that are printed in a manner that is normally impossible to be viewed by a naked eye. Hidden images are broadly used as providing anti counterfeiting measure of printed matter. Some examples include bank notes, bank checks, tickets, famous brand labels, and the like. Though hidden images are broadly used for providing anti counterfeiting measure of printed matter they may be used for amusement activities, marketing, licensing, promotional activity, merchandising ads and consumer protection, as well as for other uses. The major advantage for using hidden images as anti counterfeiting measure is within the simplicity to detect forgery performed by using a usually accessible apparatus or other aid, depending on the hidden image's type, that reveals the hidden image to the eye. According to one type of hidden image that requires an optical decoder it is sufficient to place the decoder on the printed matter's surface for enabling a person to view the presence or absence of a hidden image and consequently verifying whether the printed matter is genuine.

Methods of creating hidden images such as Moire inducing patterns, fluorescent inks, micro printing images and the like are known in the art. U.S. Pat. No. 5,708;717 by Alasia discloses a method of printing hidden images aided with computer software through the use of printers or other printing device. Alasia does not contemplate other methods of creating hidden images.

Currently known hidden images printing techniques exploit the inability of the human naked eye to view below a particular resolution. Accordingly, hidden images are printed below the resolution a human eye is able to comprehend. Nevertheless, hidden images are provided with apparatuses that enable to view the hidden images such as optic decoders, suitable illumination, magnification lenses and the like.

Another factor diminishing the extent of use of hidden images as an anti counterfeiting measure is due to reproduction ability of hidden images created through the process of print. Hidden images created through the process of printing can be revealed by changing the resolution and enlarging the printed matter wherein the hidden image exists. Once the hidden image is detected it can be scanned reproduced and printed within a counterfeited or non-original printed matter.

There is therefore a need to provide a method and an apparatus that will enable the use of hidden images in a manner that will not be limited to the type nor to the coloring of the printed matter as inserted. There is therefore a further need to provide a method to insert hidden images in a manner that will be difficult to duplicate. The invention disclosed below provides a solution for the long felt need indicated above and provides a method for inserting hidden images on a great variety of substrates for preventing reproduction of printed matters as well as for other purposes.

The technology of lasers (Light Amplification by Stimulated Emission of Radiation) is well known in the art and is used within many fields. Lasers are used for scientific research, medical diagnosis and treatment, industrial manufacturing, military use as well as many other fields. Lasers are used in many fields due to the fact that the radiation intensity and frequency can be regulated easily to correspond to the required use. Thus, small laser diodes are used for laser-jet printers and CD players and large gas lasers such as carbon dioxide lasers and solid state lasers such as Nd:YAG (Yttrium Aluminum Garnet dopped with Neodymium atoms) are used for marking cutting and welding during automobile manufacturing process. Lasers are also used for laser marking on substrates such as mark barcodes, logos, alphanumerics, part numbers, lot codes, date codes, data matrix codes and other graphics. Using lasers for marking is advantageous due to the fact that marks created by laser are permanent and are performed rapidly on a substrate. Commercial lasers can be divided into few groups: Gas lasers, solid state lasers, diode lasers and chemical lasers. Some of the lasers used commercially are diode lasers, helium-neon lasers, carbon-dioxide lasers and Nd:YAG lasers. Person skilled in the art would appreciate the importance of the laser beam quality for performing different tasks. For example: in order to have the highest power density during the marking of a substrate with a laser, the laser is preferably operated in a TEM₀₀ (transverse electromagnetic mode) mode. The TEM₀₀ mode of a laser system provides the highest power density as well as a single hot spot and a fine beam diameter similar to a theoretical Gaussian laser beam shape. One operating mode of a Nd:YAG provides a beam with wavelength of 1.064 microns. Laser systems can be operated in a continuous mode or in a pulse mode. Continuous mode provides a continuous light emission during the operating time while a pulse mode provides light emission in pulses while the pulse duration as well as the time between pulses is determined by the laser manufacturing company or by the user. Laser systems comprises: a power source preferably a stable power source; a pumping source such as a lamp, electrical spike, electrical field, another laser, the sun, voltage or current source and a like; a lasing material such as gas, a crystal, solid state device, a diode and the like and at least two resonator mirrors which can be placed external to the lasing material or being polished on at least one side of the lasing material. Pulsed laser systems further include a Q-switch mechanism which enables operating the laser in a pulse mode with controlled or predetermined repetition rate and pulse duration. Different Q-switch mechanism now available comprises passive, electro-optic, acousto-optic, mechanical Q-switches and the like.

The present invention provides a method and apparatus for providing hidden images within substrates using a laser system.

### SUMMARY OF THE PRESENT INVENTION

In accordance with one aspect of the present invention a method for providing at least one hidden image within a substrate is disclosed. The method comprising, irradiating of a light beam against a substrate, the irridating light forms an interaction with the substrate, the intercation generates an at least one hidden image, whereby the at least one hidden image can be viewed with the use of at least one decoder. The light beam used according to the method can be is a laser emitting from a laser generating mechanism. The method can further comprise the step of converting an image into a digital information, said information is used to direct the light beam. The method can further comprise the step of determining from the digital information the location for irradiating the light beam against the substrate. The step of converting the image provided into digital information can comprise calculating the locations on a substrate member on which the light beam is to be irridated. The calculating comprises selecting the features of the image located along predetermined lines or wave like lines representing the frequency to be used in the generation of the hidden image or the reverse frequency to be used in the generation of a decoder. The method provides that irridating of the light beam is performed on both sides of the substrate. According to the method the hidden image comprises text or at least one animated figure or a combination thereof. The decoder according to the method can be a flexible material embossed or irridated by a light beam with an at least one set of lines for revealing the at least one hidden image formed by the interaction of the light beam on the substrate. The substrate used according to the method can be formed from any one of the following materials: polymeric sheet, fabric, processed wood, metal sheet, or a composition of thereof. The method according to invention wherein in the irridating step the light beam forms a plurality of recesses that are about 1-50 microns in depth and are about 1-30 microns in diameter. The method can be used for determining whether the substrate is original, approved, can be used for revealing a message or an image, for determining the substrate's authenticity. According to the method the decoder can be attached to the substrate. According to the present method the light beam emits from an at least one mechanism positioned adjacent to the substrate. The light beam can emit from a laser system. The mechanism shifts position periodically against the substrate for generating the at least one hidden image. Alternatively, the laser system is fixed and the generation of the at least one hidden image is performed with at least one rotating or revolving mirror located within the at least one mechanism. According to the method the number of lines to be used in encoding of the at least one hidden image is about 1,000 lines per inch. Nevertheless, according to the method more or less than 1000 lines per inch can be provided. The method for providing the hidden image within the substrate is substantially continuous, alternatively, the method provides hidden images is discrete. The method wherein the substrate is in at least one of a three dimensional object. The method according to the present invention wherein in the irridating step the light beam forms any one of the following modification within the substrate: a recesses; a color change; a material composition change; a photochemistry reaction; a local evaporation or a scorche.

According to another aspect of the present invention a substrate comprising a hidden image is disclosed. The hidden image is generated by irridation of a light beam interacting with the substrate, the hidden image is generated in association with a frequency not visible to the naked eye, the hidden image can be seen with the use of a decoder having a reverse periodical frequency. The light beam that generates the hidden image of the substrate is a laser generated by a laser mechanism. The substrate wherein the hidden image is formed by any one of the following, a plurality of recesses, a plurality of color changes, a plurality of material composition changes, a plurality of photochemistry reactions, a plurality of local evaporations, a plurality of scorche or a combination thereof. The substrate is a material made of any one of the following, a polymeric sheet or metal sheet or processed wood or processed leather or paper or a composite material. The hidden image of substrate according to the present invention can comprise recesses in a depth of about 1-50 Microns within the substrate and a diameter of about 1-30 Microns within the substrate. The substrate of claim 27 wherein the hidden image comprises text or at least one animated figure or a combination thereof. The substrate can be used for determining whether the substrate is original or approved, for revealing a message or an image, for determining the substrate's authenticity, or for revealing the hidden image.

### BRIEF DESCRIPTION OF THE DRAWINGS

The present invention will be understood and appreciated more fully from the following detailed description taken in conjunction with the drawings in which:

FIGS. 1A, 1B, 1C illustrate an image and the insertion of the image within a printed matter creating a hidden image known in the art;

FIG. 2A illustrates an image to be embossed within a substrate in accordance to one preferred embodiment of the present invention;

FIG. 2B illustrates a perspective overview of a substrate including a hidden image in accordance to one preferred embodiment of the present invention;

FIG. 2C illustrates a side view of the recesses creating a hidden image and substrate according to one preferred embodiment of the present invention;

FIG. 2D illustrates a perspective overview of a substrate including a hidden image in accordance to one preferred embodiment of the present invention;

FIG. 3 is a flowchart of the implementation of the method and apparatus in accordance of one embodiment of the present invention;

FIGS. 4A and 4B illustrate an overview perspectives of the apparatus used in accordance to one preferred embodiment of the present invention;

FIGS. 4C, 4D and 4E illustrate protrusions used to realize preferred embodiments of the present invention;

FIG. 5 illustrates an apparatus and method used to provide hidden images in accordance to one preferred embodiment of the present invention;

FIG. 6 illustrates an apparatus and method used to provide hidden images in accordance to a second preferred embodiment of the present invention;

FIG. 7 illustrates an apparatus and method used to provide hidden images in accordance to a third preferred embodiment of the present invention;

FIG. 8 illustrates an apparatus and method used to provide hidden images in accordance to a fourth preferred embodiment of the present invention.

FIGS. 9A, 9B and 9C illustrate a hidden image within a substrate according to another embodiment of the present invention;

FIGS. 10 and 11 illustrate an apparatus and method according to another embodiment of the present invention.

### DETAILED DESCRIPTION OF THE PREFERRED EMBODIMENT

The present invention discloses a method for providing hidden images on substrates by creating recesses or protrusions on substrates. Hidden images are also known as concealed images or icons. The hidden image can be embossed on a substrate and can be viewed with a suitable decoder. Thus, the embossed image substrate according to the preferred embodiment can be provided with any shade, hue or other printed pattern on the surface of the substrate. Furthermore, the method of embossing hidden images disclosed by the present invention provides a difficult measure for counterfeiting elements. The method and apparatus disclosed by the present invention can be used for security-based applications, such as to prevent counterfeiting or copying, as well as for promotional purposes and merchandising. It can also be used for entertainment purposes and to secure the authenticity of a product or service provided. A suitable decoder made of a transparent or semitransparent polymer or laminate, such as plastic, or PVC sheet can be provided for each embossed hidden image created. The method and apparatuses presented within the invention will be provided in view of the FIGS. below.

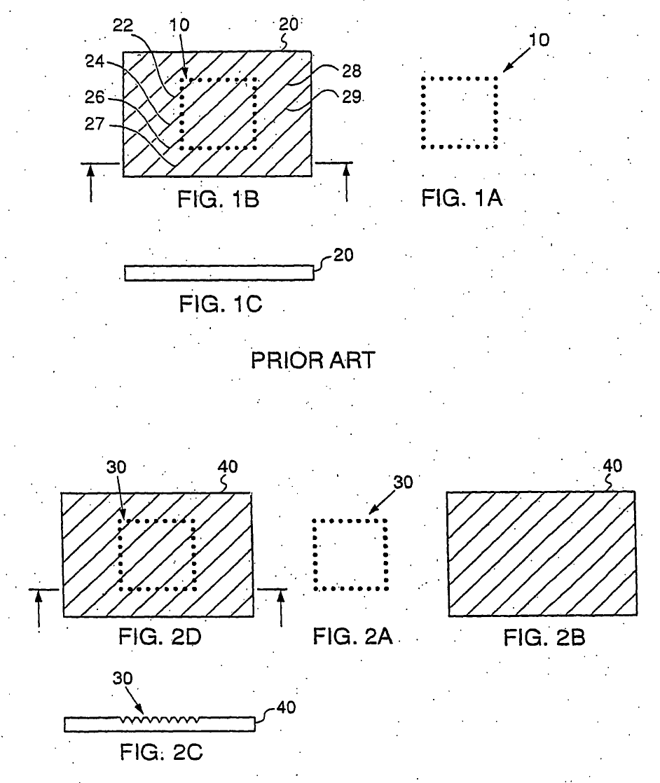

FIG. 1A illustrates an image and the insertion of the image within a printed matter creating a hidden image known in the art. Image 10 comprising ink dots and refers to printed hidden images only. The image 10 may comprise an image or letters or a phrase or other like indicia, which can later be identified as the mark of the hidden image. The image 10 can be printed in various colors. The image 10 may provide such words as “ORIGINAL” or an image or a combination thereof or like indication upon which it was printed. FIG. 1B shows printed matter 20 and a hidden image 10 within. Printed matter 20 can be any matter upon which ink can be printed. As will be described below some crucial limitations apply to the printed matter 20 which may used in association with currently available hidden images 10. Hidden image 10 printed on printed matter 20 is printed along lines 22, 24, 26, 27, 28, 29 of the printed matter 20 having fixed distance intervals between the dots comprising hidden image 10. While the lines shown in FIGS. 1B, 2B, 2D are straight, other lines such as lines in a wave form keeping a predetermined distance intervals may be used. The use of wave like lines may allow additional frequency combinations to be used for creating the hidden images. The printing of hidden image 10 along lines 22, 24, 26, 27, 28, 29 is accomplished by placing ink along the points corresponding with the hidden image 10 and the lines 22, 24, 26, 27, 28, 29. This means that ink is not placed in between the lines. Thus, a particular optic frequency between all hidden image 10 dots is created. The optic frequency is created through the use of fixed distance applied between the lines 22, 24, 26, 27, 28, 29. The printing of the hidden image 10 along the lines limits the ability of the unaided human eye to identify the hidden image. Thus, a suitable specific decoder matching the hidden image frequency created may be supplied as an aid to view hidden image 10 in a clear manner. The term hidden image frequency relates to images of all patterns such as images created by combination of lines, dots, or combination thereof, all within a substrate. Thus, an image can be comprised from periodical frequency, non-periodical frequency lines or dots. For the purpose of demonstration of the prior art only, the dots comprising image 10 within printed matter 20 are proportionally much thicker than the normal proportion between hidden image dots and printed matter lines of printed matter. There are a number of crucial factors that impose the nature of the dots and lines that are used to comprise the hidden image within any particular printed matter. Uniform background (original image) should be a normal screened half-tone image. Factors such as the darkness of colors used within the printed matter, the versatility of the colors within the printed matter and other factors. Such factors are dictated by the printed matter wherein the hidden image to be printed. Accordingly, uniform color and dark complexion colors within a printed matter provide a barrier for having a hidden image such as shown in FIG. 1B. In such cases, the uniform background will prevent users from seeing the hidden image 10 despite of the use of decoders. Additionally, when dark complexion colors are used within a printed matter the dots used for the hidden image are required to be thicker and more visible. Thus, dark color used within the printed matter requires the image to be less hidden and requires often to change colors complexion to a lighter hue and necessitate a not uniform coloring for the printed matter. Said factors as well as other requirements present difficult burden for designers, for known brands owners, as well as for others that wish to use hidden images as anti counterfeiting measure. One example for said difficulty is within well-known brands having uniform dark printed matter. Said well-known brands owners that wish to use hidden images as anti counterfeiting measure are compelled to change their well known brand. Consequently, changing a well-known brand enjoying a meaningful reputation and goodwill means loss of considerable funds.

FIG. 1C shows a side view of printed matter 20 upon which hidden image 10 is printed. As can be clearly seen from FIG. 1C the printed matter 20 substrate is flat and does include any depressions or recesses. The printed hidden image 10 is best seen when the printed matter 20 is flat enabling a horizontal surface upon which the decoder can be placed.

FIG. 2A shows an image to be embossed within a substrate in accordance to one preferred embodiment of the present invention. Image 30 presented in FIG. 2A according to the preferred embodiment of the present invention can be any kind of image shape and from any size and is not limited to image 30 shown. Additionally, image 30 can be an image such as a letter or a group of letters and sentences at any length of form and can have a statement such as “REAL”, “Authentic” or “This Product is Real”, “ORIGINAL”, “APPROVED”, “AUTHENTIC”, “<NAME OF MANUFACTURER>”, “<NAME OF PRODUCT>”, “<DATE OF MANUFACTURE>”, “<EXPIRATION DATE>”, “<BATCH NUMBER>”, “<PRIZE WON>”, and other. Image 30 may comprise an animated figure or any other image or data which may be used to convey a message to the person inspecting the product with a decoder. Image 30 may comprise a combination of words and animated figures. Image 30 may comprise two images or more each embossed using a different frequency thus allowing two different images 30 to be viewed by two different decoders or one decoder having two corresponding frequencies embedded thereupon in different angles. When such a decoder is placed on the multiple images embossed it will reveal one image when placed on the substrate in a predetermined angle and another image when placed on the substrate in the alternate angle.

FIG. 2B shows a perspective overview of a substrate including a hidden image in accordance to one preferred embodiment of the present invention. Image 30 is embossed within substrate 40 and cannot be seen by the naked eye. The lines shown on FIG. 2B are for demonstration purposes. Such lines are shown in FIG. 2B for comparison with lines 22, 24, 26, 27, 28, 29 of FIG. 1B. As noted above the lines may be formed in a wave like shape to increase the number of possibilities used to create the hidden image. Substrate 40 according to one embodiment is aluminum foil that can have famous brand tag such as Johnny Walker Black Label already printed thereon. In one example, a label for a bottle of liquor made of aluminum foil can be produced by the liquor manufacturer with the manufacturer's label on one side or on both sides. Next, a hidden image may be embossed onto the label, in accordance with the present invention. Later, the label can be attached to the liquor bottle. The image 30 is not printed and no ink is placed on the label in addition to the ink used for the preparation of the label. It will be evident to those skilled in the art that many other substrates are contemplated to be used in association with the present invention. Such can include plastic and other polymers, paper, cellophane, leather, fabric, wood, metals, and the like. Unlike the parallel example shown in FIGS. 1A and 1B, image 30 is not a part of the printed matter placed on the substrate 40 and no ink is used to create the hidden image. In addition, by the embossing process creating image 30 the said image is present at a different surface level than the print comprising the ink placed on the substrate 40.

FIG. 2C shows a side view of the recesses creating a hidden image and substrate according to one preferred embodiment of the present invention. As can be viewed in FIG. 2C image 30 is embossed within substrate 40. The size of the recesses within substrate 40 comprising image 30 according to the preferred embodiment is about 15 micro centimeters (Microns) depth and about 5 Microns diameter at surface of printed matter 40. Other recesses sizes can be used to emboss the hidden image 30 onto the substrate 40. The present invention should not be limited by technology present at the time of the invention, rather it is contemplated that with the passage of time smaller recesses can be used thus increasing the resolution of the embossed hidden image while decreasing the size of the recesses used. In addition, the smaller the recesses can be achieved the thinner the substrate 40 can be. For example, very thin cellophane can be used even without background print as a suitable substrate for the embossed hidden image 30. One such cellophane can be used to wrap a product whereby the wrap itself will indicate the authenticity of the product itself. This enables a wide variety of products to be used in association with a single manufactured wrap. In addition, the embossed hidden image contemplated by the present invention can be embossed directly on containers and substrates that are not currently used for verifying authenticity of products or for using the hidden image for other purposes. Such can include embossing the hidden image directly on a product such as a belt or perfume bottle, or a can of drink, a box of cigarettes, music or software CD or other media and the like. Such uses may be for promotional purposes, security based applications, amusement and entertainment applications, merchandising and the like. One additional example will include the embossing of the hidden image onto an employee's tag whereby the authenticity of the tag can be verified by the use of a suitable decoder. Two different images can be used on one side of the tag or on either side of the tag enabling different levels of security and authentication. In yet another example, the hidden image can embossed on the aluminum foil or other wrap of a drug marketed to consumers thus providing the ability to the consumers to verify that the drug originates from the true drug manufacturer. Another non-limiting example is the embossing of the hidden image on a product during a campaign to promote such product whereby the product bearing a specific hidden image may win a prize. Such products may be marketed directly with a decoder to enable the consumers upon the opening of the package to reveal the hidden image. To market such a product with a decoder, the decoder may be attached to the substrate into which the hidden image is embossed. The attaching of the decoder can be through the manufacturing of the decoder together with the embossed hidden image or later attaching the decoder to the embossed hidden image substrate. Moreover, the embossed hidden image can be used for security purposes and placed on substrates such wood, paper, metals and the like. To name but a few examples, the hidden image can be embossed directly on passports, security cards, keys, doors, contracts, seals, locks and the like.

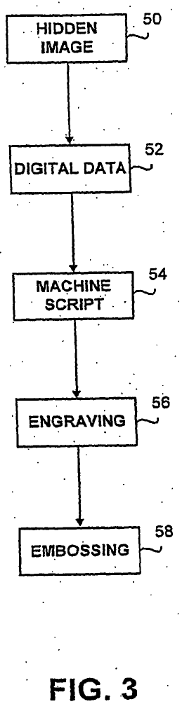

FIG. 2D shows a perspective overview of a substrate including a hidden image in accordance to one preferred embodiment of the present invention. According to the preferred embodiment of the present invention a dual measure for detection of the hidden image is provided. The hidden image 30 is embossed onto the substrate 40 through the use of an algorithm according to which the hidden image 30 is embossed across lines which create an image frequency which is not visible to the naked eye. Embossing the hidden image along various prearranged lines will enable different frequencies to be used. Corresponding visual decoders can be used to view the hidden image as embossed on the substrate 40. While FIG. 2D shows diagonal lines, such lines are not present on the substrate but are used in conjunction with a computer software for determining the distance and angle between each embossed impression on the substrate. Thus, a particular location in hidden image, which do not correspond with the predefined line, will not be embossed. The lines shown are exemplary. Various other configurations of the lines, such as horizontal or vertical as well as in various angels and forms can also be used to obtain the corresponding frequency. Computer programs which allow the determination of the correct locations for placing recesses are available and can be used to calculate the desired frequency which will enable the embossing of a hidden image onto the substrate whereby the hidden image will not be visible to naked eye; but can be visible if a decoder is used. Such decoders can be made of a transparent flexible or rigid material such as plastic, PVC, laminate and the like. The decoder will include corresponding distortions, through the use of ingressions or coloration, which will enable the decoding of the periodical frequency used resulting in the revealing of the hidden image. As noted above, the substrate according to other embodiments of the present invention can be paper of different thickness and quality, plastic and other polymer material, leather material, leather resembling materials, metals as well as other substrates. According to other embodiments of the present invention the recesses and protrusions within different substrates upon which the hidden image is embossed can vary between about 1-50 Microns depth beneath upper surface and between about 1-30 Microns diameter of recess at the upper surface of substrate. The preferred depth beneath the upper surface is about 10-20 Microns. The number of lines to be used in association with the encoding of the hidden image can reach about 1,000 per inch. Persons skilled in the art will appreciate that other combinations of the lines per inch as well as the depth and diameter of the recess can be used and that such combination may be determined according to the substrate embossed with the hidden image as well as the embossing apparatus used. A fundamental understanding of the method and apparatus used to form hidden images according to the present invention will be shown in view of FIG. 3.

FIG. 3 presents a flowchart of the steps that can be taken to provide a hidden image according to one embodiment of the present invention. In step 50 a hidden image to be embossed is loaded. The hidden image is drawn with a graphical software program and saved as a graphical software file such as a Tiff (Tagged Image File Format) file using the Photoshop computer program by Adobe, San Jose. The Tiff file is a known standardized format produced by the Microsoft Corporation for organizing pixel based image data. Other formats such as EPS (encapsulated Post Script) or vectoric illustrator files may be used alternatively to achieve 64 or 128 bit resolution. Next in step 52 the graphical hidden image data file from previous step 50 is converted to digital data format. According to the digital data conversion step 52 the hidden image data is converted from the Tiff or the like file to a digital readable data format such that each contour of the image is rendered into the production file only if it corresponds to lines 22,24,26,27,28, 29 or such lines associated with the frequency of the hidden image to be embossed. In step 54 a machine script data is prepared from the digital data file created in step 52. Steps 52 and 54 are optional and can be performed by CYNOTYPE Interface software program manufactured by by HelioCom manufactured by HelioKlischograph, Germany. The process of preparing the hidden image file to be engraved is associated with the frequency of the decoder to be used to reveal the hidden image to be embossed. In step 56 the hidden image is engraved onto a steel or metal core having a thin plated layer of copper and an additional layer of chrome on top into which the engraving of the hidden image is performed. The chrome layer is only several Microns thick and is designed to fix the information engraved on the cylinder or platform. Engraving can be accomplished using various methods such as by computer aided laser engraving directly onto the cylinder or plate u sed for the embossing step. Other methods, which can be used, include placing an engraved cylinder or plate in an acid emulsion, or through the use of a specifically designed diamond head or by a milling process through which the plate or cylinder is milled or cut later to be used for the embossing step. The engraving is performed along the lines shown in association with FIG. 2D or along similar lines determined by the operator which will enable the embossing of the hidden image onto a substrate and from which the hidden image cannot be seen by the naked eye or without an appropriate decoder. One engraving machine, also known as a gravure, can be the HelioKlischograph K500 manufactured by HELL Gravure Systems from Kiel, Germany. The K500 and like gravures can be used in some preferred embodiments of the present invention.

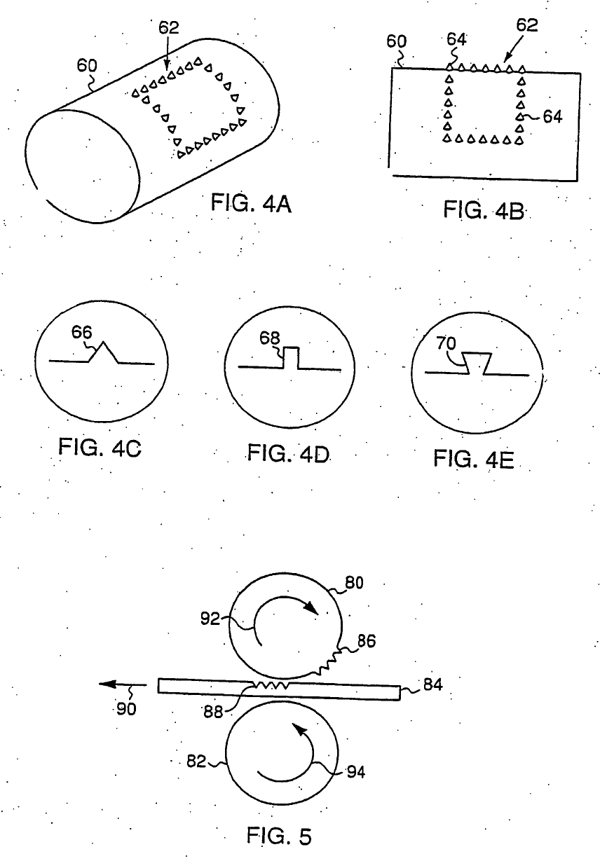

The engraving step 56 according to the preferred embodiment includes the engraving of the mirror-hidden image to be embossed on substrate on a suitable platform. Thus, engraving on said platform and providing desired protrusions enable the embossing of hidden images engraved on a substrate according to the invention. The platform to be engraved can be a cylinder roller member such as shown in FIGS. 4A and 4B. Thus, the engraving of cylinder roller member that is having its upper surface from a special durable external surface such as stainless steel with a thin layer of copper. The engraved platform can be in the size for a few Microns, preferably about 15 Microns, but suitably anywhere from 1-AM Microns depending on the ability of the engraving method used and the type of embossed substrate and depending on whether the engraving process uses heat or not. As noted above, according to the preferred embodiment the engraving step 56 is performed by high-energy laser beam that emerges from an engraving machine. Such laser beam is able to create protrusions with the precision of a number of microns. The laser beam engraves and creates protrusions on the cylinder roller member. According to other embodiments the external durable surface of cylinder roller member is a sleeve that is pulled on an embossing machine. In accordance with this alternative cylinder roller the step engraving 56 is performed on the said sleeve that is later upon completion of engraving is pulled on cylinder roller member of an embossing machine. Engraving patterns on cylinder roller members is currently being used for production of cylinder roller members used within the leather resembling materials as well as within other mass production of refined tissue paper cigarette packs and wall tapestry and the like. Other methods for engraving within the engraving step 56 can be electro mechanical or magnetic control of a diamond-head or other durable and rigid head that is controlled and activated by a machine and assisted by a computer. One example of a computer controlled electromechanical engraving machine is HelioKlischograph K500 manufactured by HELL Gravure Systems from Kiel, Germany. The engraving step 56 can be performed by a combination of laser exposure and chemical aided engraving. Alternatively the engraving can be performed through other known methods used for creating a template for embossing or other methods known for engraving on a cylinder later to be used for embossing. The engraving step 56 according to other embodiments can be performed on flat durable surface such as shown in FIGS. 7 and 8. The engraving step. 56 according to the present invention requires fine capability for creating small and exact dimensions of protrusions on the embossing plate member. The exact size and dimensions of the protrusions are set according to the embossed substrate. Thus, substrates that contain an elastic ability will require cylinder roller or flat embossing plate member containing longer and wider protrusions than substrates that do not contain such elastic capability. The preferred but not limiting length of the protrusions would preferably be about 1-50 Microns.

The final step according to the preferred embodiment of the present invention is the step of embossing 58. According to the step of embossing 58 the engraved platform now engraved is used for embossing a substrate through the placing of the engraved platform upon a substrate. According to one preferred embodiment of the present invention the engraved platform member is an engraved cylinder roller member. Embossing units such as two-station embossers, three-roll embossers, quad embossers manufactured by Industrial and Manufacturing Corporation from Pulaski, Wis., U.S.A. and other embossing units by other manufacturers can be used to implement some preferred embodiments of the present invention. According to other preferred embodiments of the present invention the step of embossing 58 includes the use of flat engraved platform as shown in FIGS. 7 and 8 below for the purpose of embossing the engraved hidden image onto the substrate. The nature of the embossing of substrate with protrusion from the engraved platform depends on the substrate's attributes especially the elastic attribute of the substrate. Each encounter between the substrate of any type and the engraved platform such as shown in FIGS. 5, 6, 7 and 8 requires a direct contact with adequate pressure for performing the embossing thus creating the hidden image below the surface of the substrate. Additionally, there are other factors relating to particular substrates that determine the embossing process such as stretching of substrate before, during and after an encounter with the engraved embossing platform member. Similarly, heating or cooling of substrate and engraved platform member can be performed before, during and after performing the embossing step 58. These factors as well as others determine the conditions used for a successful performance and lasting embossing of hidden images on substrate. According to one preferred embodiment of embossing of hidden images shown in FIG. 5 temperature is manipulated to ensure the embossing hidden images results. Thus, a substrate such as a polymer as poly vinyl chloride. (PVC) needs to be wormed prior to encountering with engraved platform. Similarly, the engraved platform is also wormed prior to encountering with PVC substrate. After embossing is performed a cooling process of the embossed substrate is recommended. Naturally, the pre-heating as well as the after cooling process influence the production output of embossed hidden image on the production line. According to other preferred embodiments of the present invention substrates such as aluminum foil do not require pre heating before nor cooling after hidden images embossing. For example when the substrate to be embossed is aluminum foil, the engraved platform protrusions should be about 15 Microns high; the process of embossing is cold; the maximum pressure to be applied to the substrate during the embossing step is about 100 Bar. The speed to be used for embossing aluminum foil is about 100 meter per minute and the process can be performed at room temperature. Another non-limiting example of a material to be embossed is poly vinyl chloride (PVC) foil. In the process of embossing the PVC foil the protrusions on the engraved platform or plate should be about 20-25 Microns in length; the process of embossing PVC foil should be hot. The PVC foil should be preheated to about 60-80 Celsius (depending on the thickness of the foil) prior to embossing; the maximum pressure to be applied to the PVC foil during the embossing process should be about 50 bar and the maximum speed used by the embossing should not exceed about 20 meters per minute. The process of heating can be performed by a pressure roller or by an external preheating unit, such as a unit using ultra red heating. In general it is noted that the speed of embossing a substrate changes in accordance with the substrate's properties, thus cardboard can be embossed at speed ranging at the about 400 meter per minutes but heated PVC speed of embossing can be as low as 15 meters per minute. Other factors related to the speed of embossing are the type of cylinder or plate used and whether the process is hot or cold.

Persons engaged in the practice of embossing from cylinders or plates will appreciate the various factors to be taken into consideration when using a flat or round copper plated steel cylinder for embossing onto a substrate.

FIGS. 4A and 4B illustrate engraved cylinder roller members in accordance one preferred embodiment of the present invention. FIG. 4A presents an overview perspective of an engraved cylinder roller member 60 having a mirror image 62 comprised from protrusions that were engraved as described above in view of FIG. 3 above. FIG. 4B presents a frontal view of the same engraved cylinder roller member 60 shown in FIG. 4A. Image 62 is comprised from protrusions 64. The protrusions 64 can be in a triangle shape as shown in FIG. 4C. FIG. 4c presents one embodiment of a protrusion shape 66 engraved on cylinder roller member 60. FIGS. 4D and 4E present other shapes of protrusions according to other embodiments of the present invention. FIG. 4D shows a triangle protrusion shape 68 and FIG. 4E shows an inverted near full triangle shape 70. Each such shape 66, 68, 70 enables the creation of different frequency to be used in association with various corresponding decoders. The decoders to be used use a corresponding a frequency to enable the human eye to view the hidden image. The shape and dimensions used for a particular substrate are dictated by the attributes of the substrate used and the requirement to insert hidden images that remain invisible and can be viewed by a decoder adjusted to frequency of the embossed dots and lines. One important advantage provided by the present invention is that the hidden image is inserted on the substrate regardless of other processes relating to the substrate. Thus, the insertion of a hidden image into a printed matter substrate can be performed at any stage in relation to the printing of the substrate—before printing or after. Furthermore, the hidden image insertion process can be separated physically and positioned at a distant location from the printing location of the printed matter.

FIG. 5 illustrates an apparatus and method used to provide hidden images in accordance with a preferred embodiment of the present invention. FIG. 5 provides a side view of substrate 84, engraved cylinder roller member 80 and cylinder roller member 82. An engraved cylinder roller member 80 embosses substrate 84 with hidden image engraved on cylinder roller member 80. Arrow 90, arrow 92 and arrow 94 indicate, respectively, the movement direction of substrate and cylinder roller members 80 and 82. The engraved protrusions 86 on cylinder roller member 80 emboss on substrate 84 hidden image 88. Though the engraved cylinder roller member 80 includes protrusions of the type shown in FIG. 4C according to other embodiments other types of protrusions such shown in FIGS. 4D and 4E as well as others can be used. The dimensions of the recesses the comprise hidden image 88 within the embossed substrate 84 are subject to the protrusions 86 on the engraved cylinder roller member 80. However, the size of the recesses 88 can change subject to the elastic attribute of substrate 84 and the pressure applied by cylinder roller members 80, 82. Thus, according to one embodiment of the present invention an embossed hidden image's recesses within a PVC resembling material substrate will reduce in size after a twenty four hour waiting period after the embossing. Accordingly, the hidden images embossing process within a substrate with an elastic attribute will require an engraved cylinder roller member with large protrusions that will provide a lasting embossed hidden images within said substrate. According to the preferred embodiment as presented in FIG. 5, cylinder roller member 82 provides a support to embossed substrate 84 during the hidden image's embossing process. The process described above can be used as an anti counterfeiting measure of important documents and labels attached to products or on wrappers or directly on products or materials.

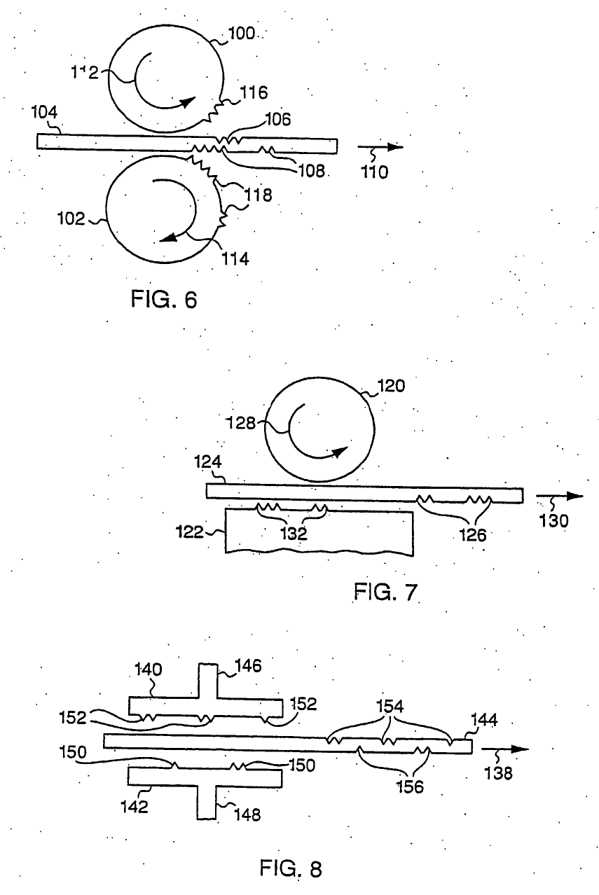

FIG. 6 presents an apparatus and method used to provide hidden images in accordance to a second preferred embodiment of the present invention. According to another preferred embodiment of the present invention embossing of hidden image's is performed from both sides of substrate 104. The apparatus for embossing according to the present preferred embodiment comprises engraved cylinder roller member 100 and engraved cylinder-roller member 102 that emboss hidden image's from both sides of substrate 104. The engraved cylinder members shown are each an embossing platform member. Arrow 110 indicates the direction of movement of substrate 104. Arrow 112 indicates the direction of movement of engraved cylinder roller member 100 and arrow 114 indicates the direction of movement of engraved cylinder roller member 102. According to one embodiment the embossed recesses can be viewed each side separately. Thus, embossed hidden image 106 created by protrusions 116 can be viewed by a decoder only from one side and embossed hidden image's 108 created by protrusions 118 can be viewed only from one side. This embodiment can be used for bank notes, documents and the like. According to another embodiment embossed hidden image's 108 performed by protrusions 118 can be viewed on the other side of substrate 104 as well. Similarly, embossed hidden image's 106 performed by protrusion 116 can be viewed at both sides of substrate 104. According to the preferred embodiment the hidden image's that can be viewed from both sides have a different frequency of dots and lines that comprise the hidden images thus, viewing hidden images performed at different sides of substrate 104 requires different decoders. Consequently, providing each side of substrate 104 with an identification of one or more hidden images. Such can be for example employee identification tag described above allowing a number of security levels to be embedded in the tag or one or more hidden image applied into a substrate for promotional purposes. Another example is applying the hidden image to a substrate such as paper to prevent counterfeiting of documents.

FIG. 7 illustrates another preferred embodiment of the present invention wherein hidden images 126 are inserted within substrate 124. According to the preferred embodiment plate embossing member 122 includes protrusions 132 that comprise an image. Substrate 124 having a direction of movement as indicated by arrow 130 is embossed by protrusions 132. Substrate 124 can be compelled by cylinder roller 120 having direction of movement indicated by arrow 128. Recesses 126 received from the embossing comprised the hidden image within substrate 124. According to the preferred embodiment plate embossing member 122 with protrusions 132 is static.

FIG. 8 presents another preferred embodiment according to the present invention. According to this preferred embodiment substrate 144 is embossed from both sides by plate embossing member 140 with protrusions 152 and by plate embossing member 142 with protrusions 150. Protrusions 152 comprise a mirror-hidden image engraved on embossing member 140. An embossed hidden image is embossed on the upper face substrate 154 and is represented as recesses 154 or 156. Similarly, protrusions 150 on plate embossing member 142 can emboss a hidden image comprised from recesses 156 on the lower face of substrate 144. According to the preferred embodiment the direction of movement of substrate 144 is indicated by arrow 158. Plate embossing member 140 is connected to handle 146 and plate embossing member 142 is connected to handle 148. Handles 146 and 148 are connected to hydraulic mechanism electrically operated and computer controlled to effectively emboss both the upper and lower face of substrate 144. According to this method and apparatus a substrate may include an embossed hidden image on either face of substrate 144 enabling a variety of uses for the substrate. Thus, for example, substrate 144 can be used for documents that can be authenticated from either side as original. In addition, each embossed hidden image can have a different frequency thus enabling the use of more than one decoder to examine the same product in association with which substrate 144 is used. In one example, a CD Rom can be embossed with different hidden images on the side opposite the side having digital information embedded on making it difficult for counterfeiters to unlawfully copy the original.

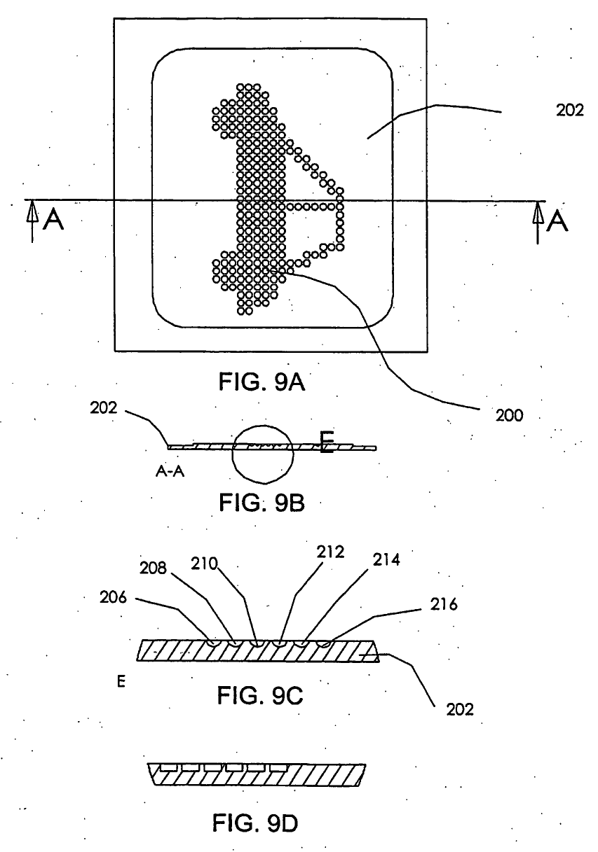

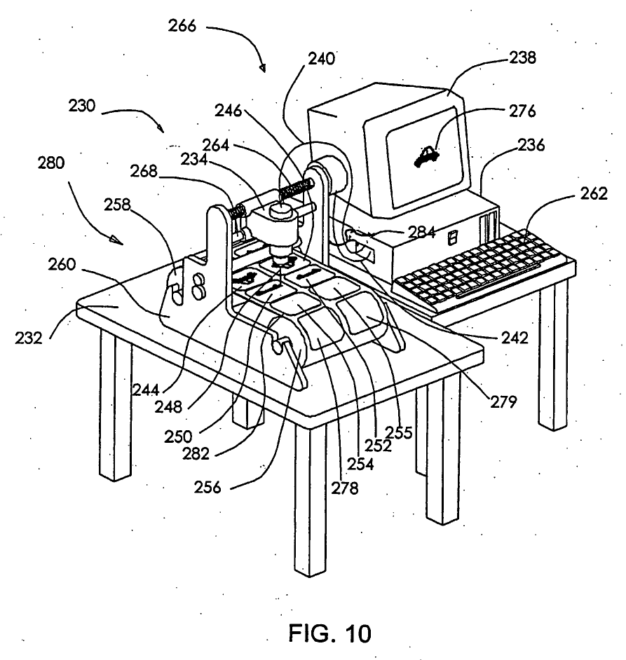

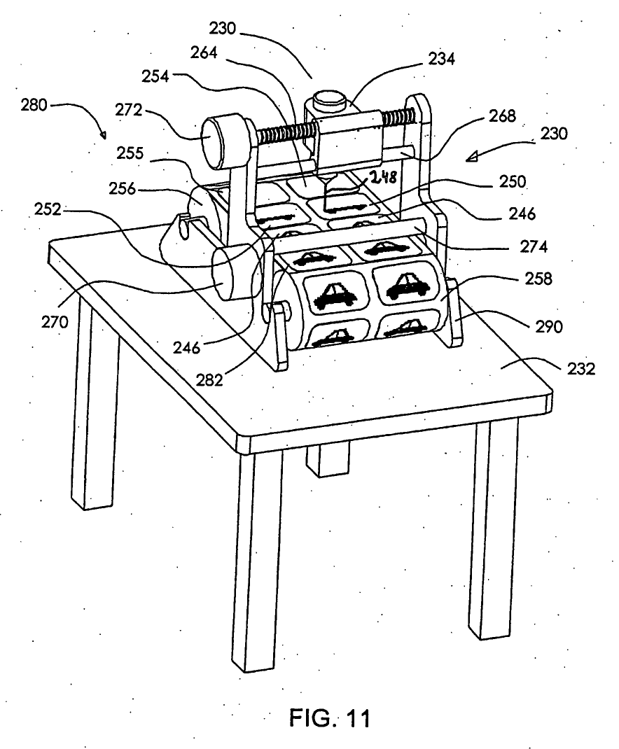

FIGS. 9A, 9B and 9C illustrate a hidden image overview and isomeric side view, respectively, within a substrate according to another embodiment of the present invention. Hidden image 200 is within substrate 202. Hidden image 200 is created from recesses within substrate 202. The method used to create hidden image 200 within substrate 202 according to the present embodiment is by a light beam such as a laser beam (not shown). The method for creating hidden images within substrates is depicted below in view of FIGS. 10 and 11. Hidden image 200 is created from recesses generated by laser beams aimed at substrate 202. The laser beam forms interaction with substrate 202 and the interaction generates hidden image 200. Hidden image 200 can be any kind of image shape and from any size and is not limited to hidden image 200 shown. Additionally, hidden image 200 can be an image such as a letter or a group of letters and sentences at any length or form, can have a statement as depicted in view of FIGS. 1 and 2 above. Furthermore, hidden images within substrates according to the present embodiment can include a variety of different designated images, numeric data such as date, batch number of product or other information, or a combination thereof. Hidden image 200 is provided with a resolution of 1200 dpi (dots per square inch). Nevertheless, according to other embodiments other resolutions of images can be provided ranging from 500-5000 dpi. Substrate 202 is an aluminum foil that contains printed matter (not shown). Hidden image 200 can be a famous brand tag. According to other embodiments other substrates are contemplated to be used in association with the present invention. Such can include plastic and other polymers, paper, cellophane, leather, fabric, wood, metals, and the like. Hidden image 200 is placed on the substrate 202 and no ink is used to create the hidden image. Hidden image 200 is not a part of the printed matter or the top surface of substrate 202. Thus, the recesses forming hidden image 200 by a laser beam (not shown) the the said image is present at a different surface. The isomeric view presented in FIG. 9B and 9C present a side view of substrate 202 and hidden image 200 at the line AA. FIG. 9C is a blow-up section E extracted from FIG. 9B. The isomeric view presents recesses 208, 210, 212, 214 and 216 within substrate 202. Recesses 208, 210, 212, 214 and 216 as well as all the recesses forming hidden image 200 are crater shape and have depth of 5-20 Microns and a diameter of 5-20 micron. Alternatively, the recesses may have a different shape depending at the laser and the substrate characteristics. For example the recesses can have rectangular cross section when manipulating the laser beam shape to a flat top called a top hat and using a metal as a substrate. The last shape of recesses, thus, recesses with rectangular cross section is shown in view of 9D. According to other embodiments of the present invention hidden images formed by a light beam irridated on a substrate can create a color change, a material composition change, a photochemistry reaction, a local evaporation or a scorche. These changes result of the irridation of a light beam, such as a laser or other, on a substrate. Each of the said changes are subject to the substrate used and the quality of the irridation.

According to other embodiments recesses formed by a laser beam can be about 1-50 microns in depth and about 1-30 microns in diameter. The different sizes of recesses used depend on the laser used and substrate used for creating the hidden image. As depicted above the recesses performing hidden image 200 are set according to a specific frequency. The frequency of the recesses performing the hidden image does not provide an ordinary naked eye of a person to recognize that the substrate has within a specific hidden image. Similarly as depicted above the way to view the hidden image 200 is by using a decoder (not shown) that is set to project the hidden image 200 to the naked eye by correlating the decoder's frequency to the recesses of hidden image 200. The laser beam for creating hidden image 200 is a Linemark 5W-Yag-Air Cooled Laser System manufactured by Metronic a subsidiary company of HF Company from Esvres sur Indre, France. The operation mode used for forming hidden image 200 on substrate 202 is TEM₀₀ mode with a repetition rate of 20 KHz. The Linemark laser system is controlled by a computer with Full Graphic Interface: including Marca™ software, protection key, electronic board, external support for connectors and Ethernet cable (TCP/IP). The user graphic interface can work with BMP files, DXF files, JPG files and other. One skilled in the art can appreciate that other laser systems can be used for forming hidden images on various different substrates according to the present invention. Persons engaged in the practice of photochemistry or lasers will appreciate the various factors to be taken into consideration when using a laser for creating a photo reaction or and interaction between a laser and a material. Such factors for example are: laser wavelength, laser beam quality, laser peak power, laser repetition rate, pulse duration, laser beam diameter, number of pulses to be burst at each recesses 208, 210, 212, 214, condensing lenses and the like.

Forming hidden images with a laser beam provides a rapid way of inserting a hidden image within a substrate. Furthermore, the laser can be diverted using mirrors (not shown) thus the substrate can have any 3 dimensional shape (sphere, cylinder, rectangular and the like) and can be position in different orientation relative the laser than what is shown here. Subject to the software used with the full graphic interface of the Linemark laser system the hidden image created within a substrate can be easily changed. Thus, one hidden image can replace another without technical requirements from the user (not shown) of the laser system.
FIG. 10 and FIG. 11 illustrate an apparatus and method according to another embodiment of the present invention. Apparatus 266 comprises, a laser mechanism 230, a hidden image insertion production line 280 and a computer 236. Apparatus 266 inserts hidden images within tags. The tags 278, 279, 254, 255, 250, 252, 244, 246 are the substates or substrate members that are provided with hidden image according to the present embodiment. The embodiment presented in FIGS. 10 and 11 present a substantially continues method for providing hidden images. Accordingly, apparatus 266 can be placed as part of a production line or, alternatively, on its own regardless from the production line that uses tags with hidden images inserted. Thus, tags with hidden images produced with apparatus 266 can be added on to products manufactured earlier or later than the production of said tags. According to other embodiments of the present invention hidden images provided with a light beam can be provided in a discrete manner. The hidden image insertion production line 280 is positioned on production table 232. Laser mechanism 230 can be a laser system. Laser system 230 is connected and controlled by computer 236. Computer 236 is a computer suited for operating a graphical user interface and is comprises a central processing unit (CPU) such as Pentium V manufactured by Intel (not shown) or other, a memory component (not shown), a hidden image insertion module (not shown), a communication device (not shown), an input device such as a pointing device (not shown), keyboard 262 or other, and an output device such as screen 238 or other. Laser system 230 can be a Linemark laser system as depicted in view of FIG. 9 above. Laser system 230 is connected to computer 236 with connecting cable 240. Screen 238 presents image 276 that is to be inserted as a hidden image within tags as depicted below. According to the present embodiment a user can alter the image chosen or, alternatively, choose another image, a written text image, or a combination thereof. The conversion of an image to into a digital format is depicted in view of FIG. 3 above. Laser system 230 according to the present invention calculates the locations on a substrate member on which the light beam is to be irridated. The calculating comprises selecting the features of the image located along predetermined lines or wave like lines representing the frequency to be used in the generation of the hidden image or the reverse frequency to be used in the generation of a decoder. Laser system is positioned within hidden image insertion production line 280. Laser system 230 is positioned in a manner that laser beam 248 is substantially perpendicular to substrate tape 282 prepared for receiving recesses from beam 248 as depicted in view of FIG. 9 above. Laser system 230 is positioned on worm shaft 264 and guiding rail 268. Worm shaft 264 is pivotally connected to motor 272. Motor can be a LCE servo motor manufactures by Anorad Corporation from New York, U.S.A. Motor 272 is connected with connecting cable 242 to computer 236. Computer 236 controls the operation of motor 272. Worm shaft 264 moves laser system 230 and consequently laser beam 248 over substrates for creating a hidden image according to image provided by computer 236. Revolving rod 274 conveys substrate tape from substrate cylinder roll 256 to substrate cylinder roll 258 with hidden image. Revolving rod 274 is connected to motor 270. Motor 270 can be a motor similar to motor 272. Motor 270 is connected to computer 236 with connecting cable 284. Computer 236 controls the operation of motor 270. Supporting walls 260 and 290 provide support to laser system 230, worm shaft 264, guiding rail 268 revolving roll 274 as well as to motors 270 and 272 and cylinders 256 and 258. Tags according to the present embodiment are flexible and are fabricated from P.V.C. with a width of 0.25 millimeters. Tags 250 and 252 are tags processed to to have hidden images inserted by beam 248. Tags 244 and 246 are tags that the hidden images was inserted by beam 248. Subject to the flexibility of tags as shown in FIGS. 10 and 11 the tags are rolled around in a cylinder shape. Thus, providing cylinder 256 as the feeder to hidden image insertion production line 280 and cylinder 258 to comprising all tags inserted with hidden images. Due to the controlling ability of computer 236 over motors 270 and 272 and laser system 230 computer 236 controls the entire insertion process of hidden images within tags.

One skilled in the art can easily appreciate that a laser system can be used to insert hidden images within items that are not flexible or, alternatively, semi-flexible. Furthermore, according to other embodiments other laser systems can be used for inserting hidden images on large items or on thin printed matter. According to aspects of the present invention laser systems can irradiate hidden images on three dimensional objects. Thus, for example metal plates, plastic materials, glass and plastic bottles for the cosmetic industry, automobile parts and other. According to further embodiments of the present invention a hidden image can be created within a substrate that is a part of an item which can be two or three dimensions by not moving the laser system as depicted in view of FIGS. 10 and 11. According to the last embodiment the laser system is fixed and the image is created by using mirrors that are incited by one, two or more mirrors. Accordingly, the laser system connected to computer creates a hidden image on a substrate by emitting the laser that is incited to different location on the substrate to create the hidden image.

The person skilled in the art will appreciate that what has been shown is not limited to the description above. Many modifications and other embodiments of the invention will be appreciated by those skilled in the art to which this invention pertains. It will be apparent that the present invention is not limited to the specific embodiments disclosed and those modifications and other embodiments are intended to be included within the scope of the invention. Although specific terms are employed herein, they are used in a generic and descriptive sense only and not for purposes of limitation.

It will be appreciated by persons skilled in the art that the present invention is not limited to what has been particularly shown and described hereinabove. Rather the scope of the present invention is defined only by the claims, which follow.

1. A method for providing at least one hidden image within a substrate the method comprising irradiating of a light beam against a substrate the irradiating light forming an interaction with the substrate, the interaction generates an at least one hidden image, whereby the at least one hidden image can be viewed with the use of at least one decoder.

2. The method of claim 1 wherein the light beam is a laser emitting from a laser generating mechanism.

3. The method of claim 1 further comprising the step of converting an image into a digital information, said information is used to direct the light beam.

4. The method of claim 1 further comprising the step of determining from the digital information the location for irradiating the light beam against the substrate.

5. The method of claim 3 wherein the step of converting the image provided into digital information comprising calculating the locations on a substrate member on which the light beam is to be irradiated.

6. The method of claim 5 wherein the calculating comprises selecting the features of the image located along predetermined lines or wave like lines representing the frequency to be used in the generation of the hidden image or the reverse frequency to be used in the generation of a decoder.

7. The method of claim 1 wherein the irradiating of the light beam is performed on both sides of the substrate.

8. The method of claim 1 wherein the hidden image comprises text or at least one animated figure or a combination thereof.

9. The method of claim 1 wherein the decoder is a flexible material embossed or irradiated by a light beam with an at least one set of lines for revealing the at least one hidden image formed by the interaction of the light beam on the substrate.

10. The method of claim 1 wherein the substrate is formed from any one of the following materials: polymeric sheet, fabric, processed wood, metal sheet, or a composition of thereof.

11. The method of claim 1 wherein in the irradiating step the light beam forms a plurality of recess that are about 1-50 microns in depth.

12. The method of claim 1 wherein in the irradiating step the light beam forms a plurality of recess that are about 1-30 microns in diameter.

13. The method of claim 1 wherein the at least one hidden image is used for determining whether the substrate is original or approved.

14. The method of claim 1 wherein the at least one hidden image is used for revealing a message or an image.

15. The method of claim 1 wherein the at least one hidden image is used for determining the substrate's authenticity.

16. The method of claim 1 wherein the decoder is attached to the substrate.

17. The method of claim 1 wherein the light beam emits from an at least one mechanism positioned adjacent to the substrate.

18. The method of claim 17 wherein the light beam emits from a laser system.

19. The method of claim 17 wherein the at least one mechanism shifts position periodically against the substrate for generating the at least one hidden image.

20. The method of claim 18 wherein the laser system is fixed and the generation of the at least one hidden image is performed with at least one rotating or revolving mirror located within the at least one mechanism.

21. The method of claim 1 wherein the number of lines to be used in encoding of the at least one hidden image is about 1,000 lines per inch.

22. The method of claim 1 wherein the method for providing the at least one hidden image within the substrate is substantially continuous.

23. The method of claim 1 wherein the method for providing the at least one hidden image within the substrate is substantially discrete.

24. The method of claim 1 wherein the substrate is in at least one of a three dimensional object.

25. The method of claim 1 wherein in the irradiating step the light beam forms any one of the following modification within the substrate: a recesses; a color change; a material composition change; a photochemistry reaction; a local evaporation or a scorch.

26. (canceled)

27. A substrate comprising a hidden image, the hidden image is generated by irradiation of a light beam interacting with the substrate, the hidden image is generated in association with a frequency not visible to the naked eye, the hidden image can be seen with the use of a decoder having a reverse periodical frequency.

28. The substrate of claim 27 wherein the light beam that generates the hidden image is a laser generated by a laser mechanism.

29. The substrate of claim 27 wherein the hidden image is formed, by any one of the following, a plurality of recesses, a plurality of color changes, a plurality of material composition changes, a plurality of photochemistry reactions, a plurality of local evaporations, a plurality of scorch or a combination thereof.

30. The substrate of claim 27 wherein the substrate is a material made of any one of the following, a polymeric sheet or metal sheet or processed wood or processed leather or paper or a composite material.

31. The substrate of claim 27 wherein the hidden image comprises recesses in a depth of about 1-50 Microns within the substrate.

32. The substrate of claim 27 wherein the hidden image comprises recesses having a diameter of about 1-30 Microns within the substrate.

33. The substrate of claim 27 wherein the hidden image comprises text or at least one animated figure or a combination thereof.

34. The substrate of claim wherein the hidden image is used for determining whether the substrate is original or approved.

35. The substrate of claim 27 wherein the hidden image is used for revealing a message or an image.

36. The substrate of claim 27 wherein the hidden image is used for determining the substrate's authenticity.

37. The substrate of claim 27 further comprising a decoder attached thereto for revealing the hidden image.

38. (canceled)
